(19) United States
(12) Patent Application Publication
(10) Pub. No.: US 2008/0232213 A1
(43) Pub. Date: Sep. 25, 2008

(54) Feedback Control Loop for Bit Detection in an N-Dimensional Data Block

(75) Inventors: Johannes Wilhelmus Maria Bergmans, Eindhoven (NL); Albert Hendrik Jan Immink, Eindhoven (NL); Jamal Riani, Eindhoven (NL); Willem Marie Julia Marcel Coene, Eindhoven (NL); Steven Jena-Marie Lucie Van Beneden, Eindhoven (NL); Massimo Ciacci, Eindhoven (NL); Ali Nowbakht Irani, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,320

(22) PCT Filed: Jan. 24, 2005
(86) PCT No.: PCT/IB05/50263

§ 371 Date: Jul. 20, 2006

(30) Foreign Application Priority Data
Jan. 26, 2004 (EP) 04100273.4

(51) Int. Cl. G11B 5/58

(52) U.S. Cl. 369/53.17

(57) ABSTRACT

On existing DVD and CD players a control loop is required for the adaptation and timing recovery. For Two-Dimensional Optical Storage such a control loop has drawbacks because PRML detection in the form of a stripe-wise Viterbi detector is used. Such a detector introduces an increasing detection delay when going from the outer rows towards the center of the broad spiral. A feedback loop is arranged to determining an error signal from a first area of the data block where the first area is that area where the error signal can be determined within the shortest period of time. This reduces the duration of the detection step and thus increases the stability of the control loop.

This invention relates to a feedback control loop for controlling parameters of a signal comprised in a block of data stored in a N-dimensional data block on a record carrier where the decision directed feedback loop comprises an input for receiving an information from the record carrier and error signal derivation means for deriving an error signal from the information, a method for controlling parameters in a feedback control loop of a signal comprised in a block of data stored in a N-dimensional data block on a record carrier and an apparatus for reading an optical record carrier comprising a feedback control loop.

Such control loops are known from existing DVD and CD players where the control loop is required for the adaptation and timing recovery.

For Two-Dimensional Optical Storage such a control loop has drawbacks because PRML detection in the form of a stripe-wise Viterbi detector is used. This detector introduces an increasing detection delay when going from the outer rows towards the center of the broad spiral. For fast control loops in a decision directed mode instability would occur because of the delay introduced by the detector. Further more the large span of the 2D inter-symbol interference at higher densities and tilt, leads to a large 2D Equalizer which introduces even more delay. In addition, write-channel imperfections such as time-varying lattice distortion due to multiple-pass mastering require independent timing recovery on each row within the broad spiral.

It is an objective of the invention to provide a stable control loop for use in two dimensional optical storage.

To achieve this objective the control loop is characterized in that the feedback loop is arranged to determine an error signal from a first area of the N-dimensional data block where the first area is that area where the error signal can be determined within the shortest period of time.

Because the detection of data in areas, for instance rows, of a two dimensional data block, which can be for instance a section of a broad spiral, is performed in a predetermined order it is advantageous to select that area of the data block where detection is performed first and establish the error signal for the control loop based on the detection results of this area. The stability of the control loop is consequently increased when the delay caused by the detection step is minimized.

An embodiment of the feedback control loop is characterized in that the first area is a guard band area corresponding to the N-dimensional data block.

The guard band comprises known data and consequently it is advantageous for the detection to start from the guard band because the detection needs to deal with less unknown factors. By selecting the guard band as the first area, i.e. the area where the error signal for the control loop is derived from, a synergistic effect is achieved. The detection is more reliable and the control loop is at the same time more stable compared to another choice of starting point for the detection.

An embodiment of the feedback control loop is characterized in that feedback control loop is arranged for controlling parameters of a signal from a second area based on the error signal derived from the first area.

Instead of deriving an error signal from each area of the N-dimensional data block the error signal derived from the detection performed on the first area is also used for other areas of the N-dimensional data block. This greatly simplifies the control loop and ensures stability for the entire N-dimensional data block because the stability of the control loop is only dependent on the delay introduced by the detection performed on the first area and not on the delay introduced by the detection performed on the other areas.

An embodiment of the feedback control loop is characterized in that the second area is the N-dimensional data block.

Instead of deriving an error signal from each area of the N-dimensional data block only the error signal derived from the detection performed on the first area is also used for all other areas of the N-dimensional data block. This greatly simplifies the control loop and ensures stability for the entire N-dimensional data block because the stability of the control loop is only dependent on the delay introduced by the detection performed on the first area and not on the delay introduced by the detection performed on any of the other areas.

The basic assumption that leads to a solution is that the fast parameter variations are common for all rows within a broad spiral. This assumption is based on the insight of the physical mechanisms that lead to these variations in the channel. For instance, small variations in the physical thickness of the cover layer of the disc (on top of the information layer containing the marks) can cause time-dependent channel variations that are common to all bit-rows in the spiral i.e. it will generate some amount of spherical aberration in the read-out spot which is common for all the bit-rows. This assumption allows the control loops to do control on all rows based on information from the outer rows only which have only a relative small detection delay.

An embodiment of the feedback control loop is characterized in that the parameters of the signal from the second area are uniformly controlled using the error signal.

An embodiment of the feedback control loop is characterized in that feedback control loop is arranged for controlling parameters of a signal from a second area based on the error signal derived from the first area and a further error signal derived from a third area. An N-dimensional data block of ten has more than one guard band. For instance a two-dimensional data block in the form of a broad spiral can have two guard bands, one guard band on each side of the broad spiral. Detection can start simultaneously from each guard band and progress simultaneously towards each other in the direction of the center of the N-dimensional data block. There is consequently an equal delay introduced by each detection performed on the various guard bands. From each detection an error signal can be derived in an equal amount of time but with differences in the actual error signal.

By taking multiple error signals into consideration no additional delay is introduced but a more appropriate response of the control loop is achieved.

An embodiment of the feedback control loop is characterized in that the parameters of the signal from the second area are uniformly controlled using an average of the error signal and the further error signal.

When considering multiple error signals an average of the multiple error signals is an appropriate input for the control loop and allows a single error signal to be used for controlling the parameters of the signal from the second area in a uniform manner because deviations from the optimum control of the parameters are minimized on average.

An embodiment of the feedback control loop is characterized in that the parameters of the signal from the second area are controlled using an interpolated error signal derived by interpolating between the error signal and the further error signal based on a position of the third area relative to the first area and the second area.

In reality small and probably slow variations occur relative between rows. These slow variations are combatted by correction loops that are based on delayed information from the inner rows. These correction loops can be controlled using an estimation of the appropriate error signal for that inner row derived by interpolation between the error signals derived from the guard bands.

An N-dimensional data block often has more than one guard band. For instance a two-dimensional data block in the form of a broad spiral can have two guard bands, one guard band on each side of the broad spiral. Detection can start simultaneously from each guard band and progress simultaneously towards each other in the direction of the center of the N-dimensional data block. There is consequently an equal delay introduced by each detection performed on the various guard bands. From each detection an error signal can be derived in an equal amount of time but with differences in the actual error signal.

By taking multiple error signals into consideration no additional delay is introduced but a more appropriate response of the control loop is achieved.

The error signals derived from the detection performed on the two guard bands represent extremes in the data block and the appropriate error signal for the areas between the guard bands can be derived by interpolation of the extremes. For instance when having a broad spiral with 12 rows, of which row 1 and 12 are guard bands, the appropriate error signal for row 4 can be determined by interpolation to be the error signal of row 1 plus 40% of the differences between the error signal derived from row 1 and the error signal derived from row 12. This interpolation is much quicker than waiting for the detection being performed on row 4 and thus increases the stability of the control loop when performing detection on row 4.

An embodiment of the feedback control loop is characterized in that the feedback control loop comprises a detector with an input for receiving the information from the input and an output for providing the error signal to the feedback control loop.

The detection can be integrated into the control loop or the control loop can be directly coupled to the detection. In both cases the control loop receives the error signal from a detector that has performed detection on the information

An embodiment of the feedback control loop is characterized in that the feedback control loop is a decision directed feedback control loop.

In a decision directed feedback control loop the delays introduced is quite large and this type of control loop benefits in particular from the application of the invention.

An embodiment of the feedback control loop is characterized in that a further control loop, supplementing the control loop, is arranged to determine an error signal from a fourth area of the N-dimensional data block where the fourth area is different from the first area.

Often two control loops are used in cooperation with different characteristics regarding stability. By supplying the error signal derived from the first area where delay is lowest that control loop is stabilized. The other cooperating control loop can be supplied with an error signal from another area.

A method for controlling parameters in a feedback control loop according to the invention is characterized in that the method comprises the steps of:
receiving an information from the record carrier
deriving an error signal from the information
determining an error signal from a first area of the N-dimensional data block where the first area is that area where the error signal can be determined within the shortest period of time
controlling parameters based on the determined error signal.

Because the detection of data in areas, for instance rows, of a two dimensional data block, which can be for instance a section of a broad spiral, is performed in a predetermined order it is advantageous to select that area of the data block where detection is performed first and establish the error signal for the control loop based on the detection results of this area. The stability of the control loop is consequently increased when the delay caused by the detection step is minimized.

An embodiment of the method for controlling parameters in a feedback control loop is characterized in that the step of deriving an error signal from the information comprises the step of selecting the information from a guard band area corresponding to the N-dimensional data block

An embodiment of the method for controlling parameters in a feedback control loop is characterized in that the step of controlling parameters based on the determined error signal comprises controlling parameters of a signal from a second area based on the error signal derived from the first area.

An embodiment of the method for controlling parameters in a feedback control loop is characterized in that the second area is the N-dimensional data block.

An embodiment of the method for controlling parameters in a feedback control loop is characterized in that the parameters of the signal from the second area are uniformly controlled using the error signal.

An embodiment of the method for controlling parameters in a feedback control loop is characterized in that the step of controlling parameters based on the determined error signal comprises controlling parameters of a signal from a second area based on the error signal derived from the first area and a further error signal derived from a third area.

An embodiment of the method for controlling parameters in a feedback control loop is characterized in that the second area is the N-dimensional data block.

An embodiment of the method for controlling parameters in a feedback control loop is characterized in that the parameters of the signal from the second area are uniformly controlled using an average of the error signal and the further error signal.

An embodiment of the method for controlling parameters in a feedback control loop is characterized in that the step of controlling the parameters of the signal from the second area comprises the steps of:
interpolating between the error signal and the further error signal based on a position of the third area relative to the first area and the second area to derive an interpolated error signal.

An embodiment of the method for controlling parameters in a feedback control loop is characterized in that the step of deriving an error signal from the information comprises the step of detecting symbols from the information and providing the error signal to the feedback control loop.

An embodiment of the method for controlling parameters in a feedback control loop is characterized in that the feedback control loop is a decision directed feedback control loop.

An Apparatus for reading an optical record carrier comprising a feedback control loop benefits from the control loop according to the invention because results in a stable control loop as required for the controlling of parameters of signals derived from the optical record carrier in particular those with data stored in an N-dimensional data block such as a broad spiral.

### BRIEF DESCRIPTION OF THE FIGURES

FIG. 1: Principle of Viterbi Detection.

FIG. 2: First possible organization scheme of the stripe-wise Viterbi along the broad spiral.

FIG. 3: Second, more advantageous organization scheme of the stripe-wise Viterbi.

FIG. 4: Block Diagram of the current receiver for record carriers with data stored in a 2-dimensional pattern.

FIG. 5: Block Diagram of the timing recovery loop.

FIG. 6: Block Diagram for DC control based on the outer rows only.

FIG. 7: Block Diagram for DC control correction based on the inner rows.

FIG. 8: Block diagram in the Laplace domain of the fast control loop in combination with the slower correction loop.

FIG. 9: Variation in relative delay between adjacent rows in the broad spiral.

FIG. 10: Block diagram of the inner-outer control loop configuration for the case of timing recovery (i.e. a 2nd order loop).

FIG. 11: Step responses of the coupled first order loops.

FIG. 12: Interpolation of the error signals for intermediate rows.

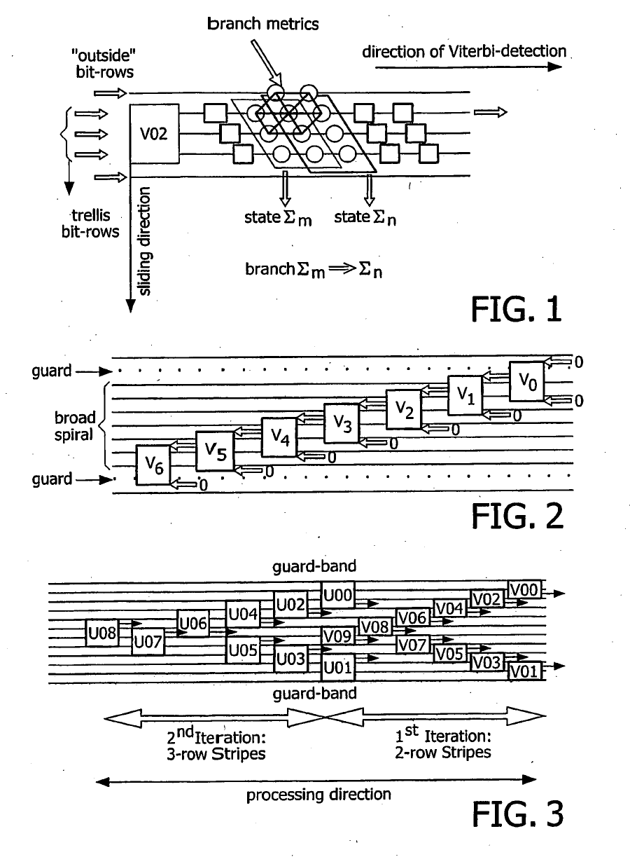

In Two-Dimensional Optical Storage bits are stored on a hexagonal lattice. In contrast to conventional optical recording (CD, DVD, BD) where the bits are stored in a single spiral the bits in 2-dimensional storage are organized in so-called broad spirals. Each broad spiral consist of a number of bit rows. Practical numbers are 9 and 11. The broad spirals are separated by a guard band consisting of a bit-row without any pits (i.e. all zeros). This guard band introduces a discontinuity in the phase relation between adjacent broad spirals to allow a constant areal density across the disc. Additionally, it serves as a starting point for 2D-bit detection. This bit-detection is preferably done with a Viterbi detector. To reduce the enormous complexity of a full-fledged 2D Viterbi, the 2D Viterbi is divided into smaller Viterbi detectors, each covering a limited number of bit-rows which are called stripes and have a typical width of 2 or 3 rows. This configuration is called a stripe-wise Viterbi Detector. The first Viterbi starts on the outer rows and uses the fact that the guard band only contains zeros as side information for the calculation of the reference levels in the branch metric calculation. The detected bits of this first Viterbi are passed to the next Viterbi to be used also here as side information for the calculation of the reference levels. This procedure is repeated until the last Viterbi processes the last rows of the broad spiral. FIG. 1 shows how it works for a single stripe 3. The Viterbi is going from state

Σₘ 1 to a next state σₙ₂. The branch metric is calculated as a sum of three contributions, one for each row within the stripe:

$$β = {\sum }_{l = 1}^{h} {\vert {H F}_{i} - {REF}_{i , d} \vert}^{2}$$

To calculate the reference signal REF (or equivalently to determine the entry point in a look-up table that stores the REF values) the cluster type is needed. Further it can be assumed for the sake of simplicity that the cluster type is based on the central bit 4 and the nearest neighbors 5A, 5B, 5C, 5E, 5F only (this is called the first shell only). To calculate the reference level for the central bit 4 the nearest neighbors 5A, 5B, 5C, 5E, 5F are needed as indicated by the hexagonal ‘spider-web’ 6 in FIG. 1. Two of these nearest neighbors 5A, 5B are bits on the ‘outside bit row’ 7A i.e. are not part of the stripe 3 to be processed.

In a first concatenation scheme of these stripe Viterbi detectors V0, V1, V2, V3, V4, V5, V6 the blocks are organized linearly along the rows in the broad spiral 21 as indicated in FIG. 2. Note that each viterbi detector V0, V1, V2, V3, V4, V5, V6 uses at the top row side information obtained from the previous Viterbi (or from the guard band in case of the first Viterbi V0) and that at the bottom zeros are used as side information because the bits are not yet knows. This causes the top-most bit of the detected output of the Viterbi detectors V0, V1, V2, V3, V4, V5, V6 to be the most reliable one. Therefore, only this bit is used as output.

A second, more advantageous organization of the Viterbi detectors is to layout the blocks in a ‘V’-shape. This is shown schematically in FIG. 3. Note, that in a final implementation two iterations are needed to achieve the required, low bit-error rate at the output of the viterbi detector V0, V1, V2, V3, V4, V5, V6, V7, V8, V9.

At the input of the bit-detector V0, V1, V2, V3, V4, V5, V6, V7, V8, V9 bit-synchronous samples that are conform with a certain, so-called target response are expected. This target response is the ideal response desirable for our optical channel. The same target response is used in the Viterbi detector to calculate the reference levels. So ideally, the input HF samples (see Eq. 1) are equal to the reference levels REF for the correct cluster under evaluation and the branch metric is equal to zero. In reality however, the channel output signal is subject to imperfections (or a target response is chosen that does not fit the nominal channel perfectly; instead other criteria for the choice of target response such as white noise at the input of the detector can be chosen). These imperfections can be a gain mismatch, DC mismatch, timing error, amplitude/phase distortion. Note further, that these imperfections in the signal may be time varying. With signal processing in the form of gain/DC control loops, timing recovery, adaptive equalizers, etc these imperfections (or mismatch) are eliminated as much as possible.

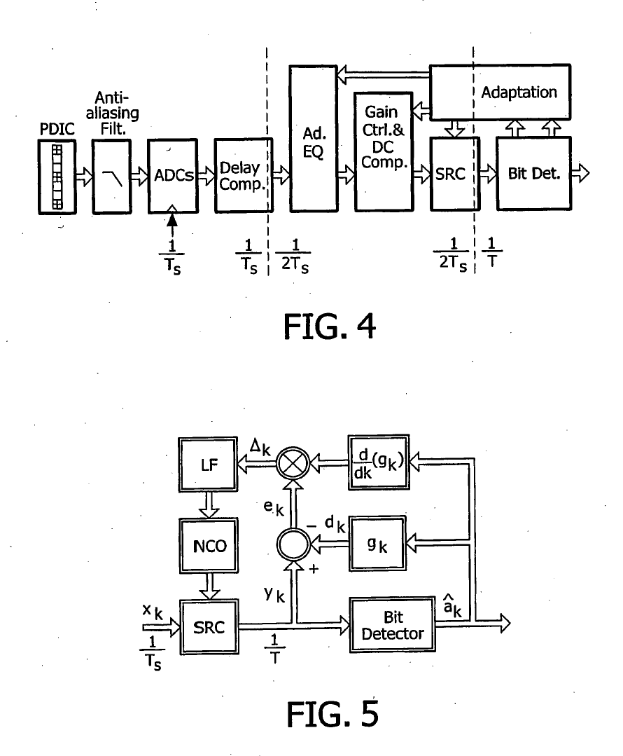

A block diagram of a typical receiver is shown in FIG. 4.

The control loops in the adaptations block 41 need some input signals that indicate a mismatch between the actual signal at the input 42 of the bit-detector 43 and the ideally expected target signal. Therefore, the actual input signal of the bit-detector 43 is compared to this ideally expected target signal (by subtracting the signals hereby generating a so-called error-signal). To calculate the ideally expected target signal the bits are needed as they are stored on the medium. In some cases these bits are known beforehand like in the case of a preamble. In this case a Data Aided (DA) mode is used where the target signal is calculated based on a known data file. However, in most cases the bits on the disc are not known and an alternative must be found.

A solution to this problem is to use the bits that are detected by the bit-detector 43 although this bit-stream might contain some errors. In this case a Decision Directed (DD) mode is used. As an example the timing recovery loop in the receiver 40 of FIG. 4 is shown in FIG. 5. Here the output of the bit detector 43 is used as input to a jitter detector gₖ₅₂ which calculates the ideal target signal dk. The actual signal at the input of the detector yₖ is compared with this signal by subtraction in subtractor 52. This results in an error signal eₖ. This error signal is mapped on a so-called signature signal by correlation (in the form of a sample-by-sample multiplication). The result is a timing error Δk which is input to the rest of the control loop. From this structure it becomes clear that the bit-detector 43 is in the control loop and therefore the delay of the bit-detector becomes important.

In case of fast varying parameters high bandwidth control loops are needed. There control loops allow only limited delay in the total loop. If the delay becomes larger the phase margin of these loops is reduced and stability problems occur. In particular for the receiver 40 of FIG. 4 this is a big problem since the stripe-wise Viterbi configuration results in large delay in the detector. For the outer rows the delay is limited to the back-tracking delay of the Viterbi . Note that this is best case. In a practical implementation at least this delay is needed to build up the trellis and in addition extra delay might be introduced in the back-tracking algorithm. With tricks like ‘register exchange’ however this delay might be minimized. For the inner rows however, detection cannot start until the side-information from the previous detector is available. Therefore, the delay increases linearly starting from the outer rows going towards the center of the broad spiral where the last Viterbi block produces the output for three bit-rows simultaneously unlike the other Viterbi blocks which only produce one output bit-row. Typical delays can be larger than 100 bits. For this reason the configuration of FIG. 3 is more beneficial than the configuration of FIG. 2 because the largest row delay in the viterbi of FIG. 2 is twice as large as in the first configuration.

The basic assumption that leads to a solution is that the fast parameter variations are common for all rows within a broad spiral. This assumption is based on the insight of the physical mechanisms that lead to these variations in the channel. For instance, small variations in the physical thickness of the cover layer of the disc (on top of the information layer containing the marks) can cause time-dependent channel variations that are common to all bit-rows in the spiral (i.e. it will generate some amount of spherical aberration in the read-out spot which is common for all the bit-rows). This assumption allows the control loops to do control on all rows based on information from the outer rows only which have only a relative small detection delay. In reality however, small and probably slow variations occur relative between rows. These slow variations are combatted by correction loops that are based on delayed information from the inner rows.

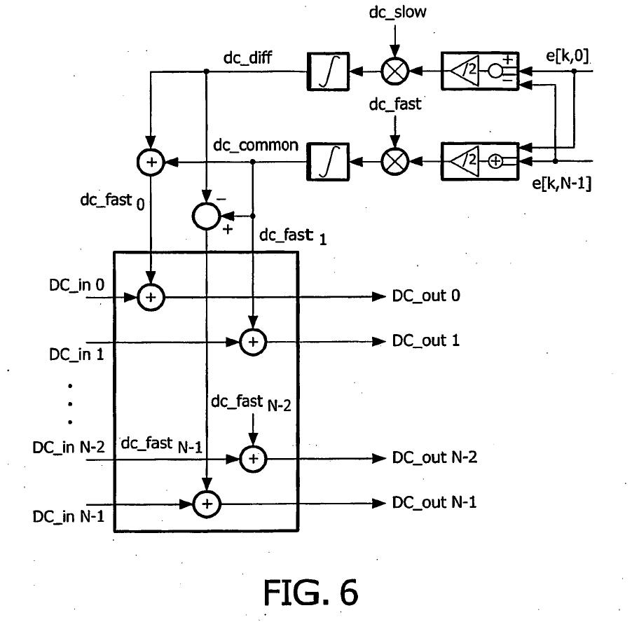

A first block diagram of this idea is shown in FIG. 6 for the case of DC-compensation. First the errors of the outer rows e[k, 0] and e[k, N−1] are averaged by averaging means 61A, 61B to form a common error signal. This common error signal is multiplied by multiplier 62A by a proportional loop constant dc_fast. The loop filter is a simple integrator 63A and outputs a dc common signal that is used for all the rows. The difference between the error signal of the outer rows is used to compensate the outer rows for relative differences that might be present between these two rows. This is done by dividing the difference in error signal by 2 by the subtractor/divider 61B and use a second proportional loop constant dc_slow which is multiplied with the result of the subtractor/divider 61B, The result of this multiplication is input to a simple integrator 63B. The output of the integrator 63A the signal dc_diff is added to the DC signal by the adder 64A for the top-row and subtracted by subtractor 64B from the DC-signal for the bottom row.

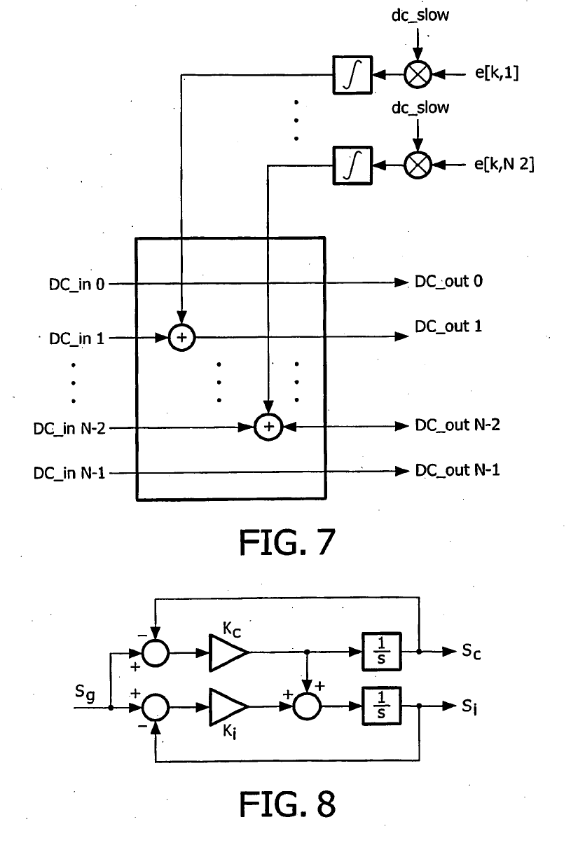

On top of this scheme correction loops are added that are based on delayed information from the inner rows. This is shown in FIG. 7. The error signal from each of the inner loops is used as input to the control loop for the corresponding row. Because both loops are first order loops it is expect that also the combination of both loops would show first order behavior (i.e. an exponential convergence to the final value in case of a step variation at the input). It appears however, that this is not true. To explain this behavior the combined control diagram in the Laplace domain can be drawn as shown in FIG. 8. It can be shown that the transfer function from the input setpoint to the output gain value for the outer rows is equal to:

$${G}_{0} = \frac{{S}_{0}}{{S}_{g}} = \frac{{K}_{c}}{s + {K}_{c}} . \qquad ( 2 )$$

which is a first order function leading to a step-response equal to:

s₀^{(t)=1}−e^{K.t} (3)

For the inner rows the transfer function is equal to:

$${G}_{i} = \frac{{S}_{i}}{{S}_{g}} = \frac{( {K}_{c} + {K}_{i} ) s + {K}_{i} {K}_{c}}{( s + {K}_{i} ) ( s + {K}_{c} )}$$

Leading to a step response equal to:

$${g}_{i} ( t ) = 1 - \frac{{K}_{i}}{{K}_{i} - {K}_{c}} {e}^{- {K}_{i}^{t}} + \frac{{K}_{c}}{{K}_{i} - {K}_{c}} {e}^{- {K}_{c}^{t}}$$

A special case occurs when Ki=Kc=K. In that case the step response can be calculated as:

The damping for the inner loops is equal to:

$$ζ = \frac{1}{2} ( \sqrt{\frac{{K}_{i}}{{K}_{c}}} + \sqrt{\frac{{K}_{c}}{{K}_{i }}} )$$

showing that the minimum damping factor is 1 for Kᵢ=K_{c}. This means that the system is always stable and thus can be used for our purpose. In practical situations K_{c} is much larger than Kᵢ and the damping factor is even higher.

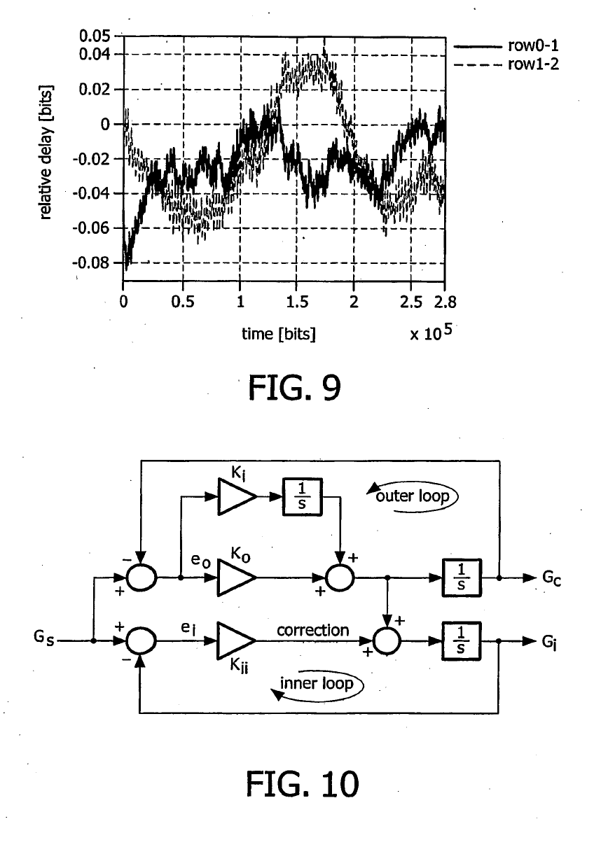

The same solution is applied to the timing recovery loops. However, generally the timing recovery loop is a second order loop. One of the integrators is the numerically controlled oscillator. For record carriers with data stored in a 2-dimensional pattern a second order timing recovery loop is applied for all rows based on information from the outer rows only. This works perfectly under the assumption that all rows have exactly the same frequency and that the relative phase between the rows does not vary. However, in practice a time-varying phase between adjacent rows in the same broad spiral is present due to the multiple-pass mastering that is currently applied to master the read only record carriers with data stored in a 2-dimensional pattern with laser beam recorders or electron beam recorders. To compensate for this time-varying phase a first order phase correction loop is applied to the inner rows. Necessarily this loop is slow due to the large delays in the bit-detection for these rows. This is not a problem because it appeared that also phase variation between rows is slow as shown in FIG. 9.

A block diagram of the second-order system is shown in FIG. 10. It can be shown that the total transfer function for the inner rows can be written as:

$${G}_{i} = \frac{{K}_{il}}{s + {K}_{il}} + \frac{( {K}_{p}^{s} + {K}_{i} ) s}{( {s}^{2} + {K}_{p} s + {K}_{i} ) ( s + {K}_{il} )}$$

which can be shown also to be stable as long as the second order system is stable.

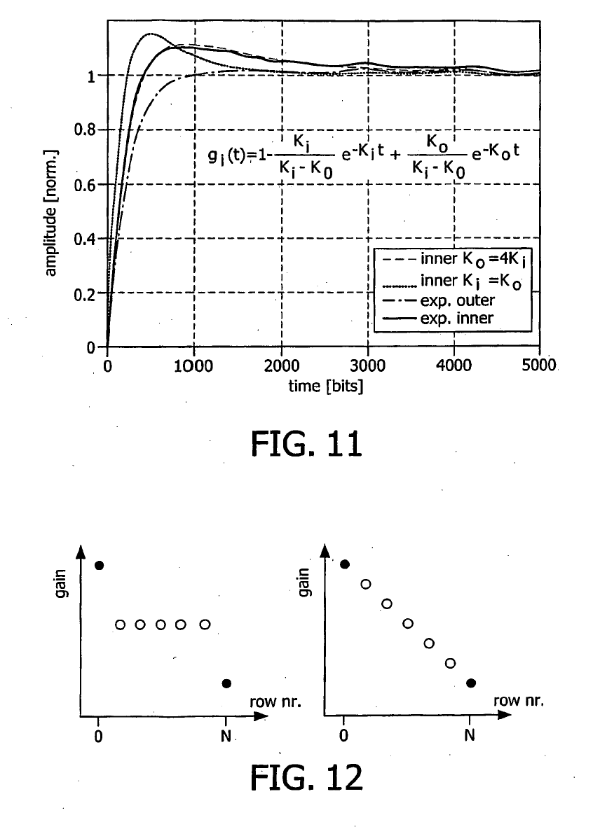

A MatLab simulation of the step response based on the equations in the previous section result in the graph of FIG. 11. The plot shows the step response together with some results from processing of data coming retrieved by the playback device from record carriers with data stored in a 2-dimensional pattern. The first curve 110 shows the situation for the inner correction loop when K₀ equals 4 times Kᵢ, the second curve 111 shows the situation for the inner correction loop when Ki equals KO. The third loop 112

In FIG. 12 of this document shows that the common parameter that was taken for the inner rows was derived from the parameter extracted from the outer rows by simply averaging the parameters for the outer rows and applying this parameter for all the inner rows. This is schematically shown in the left part of the figure below for the gain parameter as an example. However, it can be imagined that the gain value near row 0 (e.g. row 1,2) is higher than the gain value near row N (e.g. row N-2, N-1) because the extracted gain value of row 0 was considerably higher than row N. Therefore, it is reasonable to expect that a better approximation to the gain of the inner rows is obtained by linear interpolation of the two extracted gains on the outer rows (as indicated in the right figure below) instead of a simple averaging operation on the two extracted gains on the outer rows.

1. A feedback control loop for controlling parameters of a signal comprised in a block of data stored in a N-dimensional data block on a record carrier where the feedback loop comprises an input for receiving an information from the record carrier and error signal derivation means for deriving an error signal from the information, characterized in that the feedback loop is arranged to determine an error signal from a first area of the N-dimensional data block where the first area is that area where the error signal can be determined within the shortest period of time.

2. A feedback control loop as claimed in claim 1, characterized in that the control loop is a high bandwidth control loop.

3. A feedback control loop as claimed in claim 1,
characterized in that the first area is a guard band area corresponding to the N-dimensional data block

4. A feedback control loop as claimed in claim 1,
characterized in that the feedback control loop is arranged for controlling parameters of a signal from a second area based on the error signal derived from the first area.

5. A feedback control loop as claimed in claim 4, characterized that a the feedback control loop is additionally arranged for controlling parameters of a signal from the second area based on an error signal derived from the second area.

6. A feedback control loop as claimed in claim 4,
characterized in that the second area is the N-dimensional data block.

7. A feedback control loop as claimed in claim 6, characterized in that the parameters of the signal from the second area are uniformly controlled using the error signal.

8. A feedback control loop as claimed in claim 4,
characterized in that feedback control loop is arranged for controlling parameters of a signal from a second area based on the error signal derived from the first area and a further error signal derived from a third area.

9. A feedback control loop as claimed in claim 8, characterized in that the second area is the N-dimensional data block.

10. A feedback control loop as claimed in claim 8, characterized in that the parameters of the signal from the second area are uniformly controlled using an average of the error signal and the further error signal.

11. A feedback control loop as claimed in claim 8, characterized in that the parameters of the signal from the second area are controlled using an interpolated error signal derived by interpolating between the error signal and the further error signal based on a position of the second area relative to the first area and the third area.

12. A feedback control loop as claimed in claim 1,
characterized in that the feedback control loop comprises a detector with an input for receiving the information from the input and an output for providing the error signal to the feedback control loop.

13. A feedback control loop as claimed in claim 12, characterized in that the feedback control loop is a decision directed feedback control loop.

14. A feedback control loop as claimed in claim 12, characterized in that a further control loop, supplementing the control loop,
is arranged to determine an error signal from a fourth area of the N-dimensional data block where the fourth area is different from the first area.

15. A method for controlling parameters in a feedback control loop of a signal comprised in a block of data stored in a N-dimensional data block on a record carrier comprising the steps of
receiving an information from the record carrier deriving an error signal from the information determining an error signal from a first area of the N-dimensional data block where the first area is that area where the error signal can be determined within the shortest period of time
controlling parameters based on the determined error signal

16. A method for controlling parameters in a feedback control loop as claimed in claim 15,
characterized in that the step of deriving an error signal from the information
comprises the step of selecting the information from a guard band area corresponding to the N-dimensional data block

17. A method for controlling parameters in a feedback control loop as claimed in claim 14,
characterized in that the step of controlling parameters based on the determined error signal comprises controlling parameters of a signal from a second area based on the error signal derived from the first area.

18. A method for controlling parameters in a feedback control loop as claimed in claim 17,
characterized in that the second area is the N-dimensional data block.

19. A method for controlling parameters in a feedback control loop as claimed in claim 18,
characterized in that the parameters of the signal from the second area are uniformly controlled using the error signal.

20. A method for controlling parameters in a feedback control loop as claimed in claim 16,
characterized in that the step of controlling parameters based on the determined error signal comprises controlling parameters of a signal from a second area based on the error signal derived from the first area and a further error signal derived from a third area.

21. A method for controlling parameters in a feedback control loop as claimed in claim 20,
characterized in that the second area is the N-dimensional data block.

22. A method for controlling parameters in a feedback control loop as claimed in claim 20,
characterized in that the parameters of the signal from the second area are uniformly controlled using an average of the error signal and the further error signal.

23. A method for controlling parameters in a feedback control loop as claimed in claim 19,
characterized in that the step of controlling the parameters of the signal from the second area comprises the steps of:
interpolating between the error signal and the further error signal based on a position of the second area relative to the first area and the third area to derive an interpolated error signal.

24. A method for controlling parameters in a feedback control loop as claimed in claim 1,
characterized in that the step of deriving an error signal from the information comprises the step of detecting symbols from the information and providing the error signal to the feedback control loop.

25. A method for controlling parameters in a feedback control loop as claimed in claim 23,
characterized in that the feedback control loop is a decision directed feedback control loop.

26. Apparatus for reading an optical record carrier comprising a feedback control loop as claimed in claim 1.
